(19) United States
(12) Patent Application Publication
(10) Pub. No.: US 2025/0289200 A1
(43) Pub. Date: Sep. 18, 2025

(54) MOLDING TOOL AND METHOD FOR LAMINATING THREE-DIMENSIONAL MOLDED PARTS MADE OF A FIBER-CONTAINING MATERIAL

(71) Applicant: Kiefel GmbH, Freilassing (DE)

(72) Inventors: Johannes Marius van der Schans, Sprang-Capelle (NL); Cornelis Hendrikus Albertinus Decoz, Sprang-Capelle (NL)

(21) Appl. No.: 19/077,196

(22) Filed: Mar. 12, 2025

(30) Foreign Application Priority Data
Mar. 15, 2024 (DE) 10 2024 107 491.4

(51) Int. Cl. B31B 50/59; B31B 105/00

(52) U.S. Cl. CPC B31B 50/59; B31B 2105/001

(57) ABSTRACT

A molding tool for laminating three-dimensional molded parts made of a fiber-containing material, where at least one moldable laminate is applied to a surface of a molded part is described. A method for laminating three-dimensional molded parts made of a fiber-containing material are also described.

### PRIORITY CLAIM

The present application claims priority under 35 U.S.C. § 119 to German Patent Application No. DE 10 2024 107 491.4, filed Mar. 15, 2024, the disclosure of which is incorporated by reference herein in its entirety.

### TECHNICAL FIELD

A molding tool for laminating three-dimensional molded parts made of a fiber-containing material where at least one moldable laminate is applied to a surface of a molded part, and a method for laminating three-dimensional molded parts made of a fiber-containing material are described.

### BACKGROUND

Fiber-containing materials are increasingly being used to produce, for example, packaging for food (such as shells, capsules, in particular coffee capsules, boxes, lids, etc.). Recently, fiber-containing material is increasingly used that has or is made of natural fibers that can be obtained, for example, from renewable raw materials or waste paper. Fiber-containing materials can be processed in a wet state or a dry state.

For example, fiber-containing material can be suctioned out of a fiber-containing suspension (pulp) and pressed into finished molded parts. However, molded parts made of a fiber-containing material can also be produced by molding paper, cardboard, Airlaid, compressed Airlaid, and nonwoven materials, wherein the above-mentioned materials can in particular also be pressed into molded parts in multiple layers (“multilayer”). Airlaid refers to individual fibers or fiber bundles that are suctioned via a screen belt and deposited thereon to form a relatively loose fiber composite. With compressed Airlaid, these fiber layers can then be pressed.

When using molded parts made of a fiber-containing material, one challenge is to ensure a barrier against the penetration of substances from outside into the interior and thus into the product received in the molded part, as well as ensuring a barrier against the escape of substances or the product from the molded part. For example, it is known to introduce substances into the fiber-containing material during the production of the material. A disadvantage of this method is that the disposal of such molded parts is very complex because the substances contained in the material for the barrier properties are often not recyclable or compostable. Simply removing these substances is only possible with great effort, or not at all. An alternative is to laminate molded parts made of fiber-containing material with a thin film, with the film providing the barrier properties. After use, the film can be easily separated from the fiber-containing molded part so that the fiber-containing part can be composted, for example, and the film can be subjected to a further recycling step. Compostable films are also known that make it unnecessary to separate the film from the fiber-containing material because both components can be composted together.

Lamination of fiber-containing materials is usually carried out using negative pressure provided via a cavity and through the fiber-containing material, wherein a thin film applied to the cavity is suctioned and deposited on the inner or outer surface of the molded part and bonded to the fiber-containing material. For this purpose, the film is heated so that it can be more easily deformed or suctioned, and bonds with the fiber-containing material. Lamination can also be carried out using so-called molding plungers, wherein the film is pressed into a mold cavity of the cavity and is preformed. During lamination, the edge region of the film is first pressed against the edge of the molded part so that the negative pressure can act between the film and the surface of the molded part. The air pressure that builds up between the molded part and the film causes the film to bulge upward as the molding plunger moves downward, resulting in bubbles, wrinkles, holes, and poor bonding of the material. The buildup of air pressure also causes the film to be pressed onto the molding plunger, which cools it and prevents it from bonding properly with the fiber-containing material. Therefore, it is not possible to achieve a uniform distribution of a laminating material or film using the known method and design.

### SUMMARY

### Object

Thus, it is an object to provide a solution that eliminates the problems of the prior art and allows the lamination of three-dimensional molded parts made of a fiber-containing material without bubbles, wrinkles, holes, etc., wherein the film is evenly distributed over the surface to be laminated.

### Solution

The above-mentioned object is achieved by a molding tool for laminating three-dimensional molded parts made of a fiber-containing material, wherein at least one moldable laminate (laminating material, e.g., film) is applied to a surface of a molded part, including a tool body with at least one mold cavity into which a molded part made of fiber-containing material can be inserted, and a tool component with at least one molding plunger that can be displaced relative to the mold cavity and that is displaceably received in at least one chamber of the tool component, wherein the tool body and the tool component can be brought into contact with one another such that a lower edge of the at least one chamber presses against an edge of the at least one mold cavity in a contact region, and wherein the at least one displaceable molding plunger in the at least one chamber is connected to at least one first seal that can be displaced together with the at least one molding plunger in the chamber and seals a region of the at least one chamber in which the at least one molding plunger can be displaced from a remaining region of the at least one chamber.

The design of the molding tool allows lamination without the provision of negative pressure over the mold cavity of a cavity. Compared to known embodiments from the prior art, the region between the molding plunger and a laminate is sealed via the at least one seal, so that the gas or gas mixture contained therein, hereinafter referred to as “air,” forms an “air cushion” that causes or at least supports a deformation of the laminate when the molding plunger is moved in the closed state of the molding tool. The at least one first seal prevents a pressure difference above and below the laminating material. This prevents the laminating material, e.g., a film, from bulging upwards. In addition, this minimizes the contact of the laminate or film with the molding plunger, which prevents the laminating material from cooling down and improves the bonding properties to the fiber-containing material. In addition, the material distribution of the laminating material can be controlled by the shape of the molding plunger.

Advantageously, an air cushion can thus form on the surface of the molding plunger facing the film, which presses the film downwards so that there is substantially no direct contact between the surface of the molding plunger and the film.

In further embodiments, at least one second seal can be arranged in the contact region between the edge of the at least one mold cavity and the at least one chamber in order to better seal the space between the laminate (e.g., film) and the first seal, in which the molding plunger is displaced, in the closed state of the molding tool.

In further embodiments, the at least one second seal can be arranged on the lower edge of the at least one chamber.

In further embodiments, the at least one molding plunger and the at least one mold cavity can have a substantially complementary geometry, whereby the distribution of the laminate (the film) is adapted with respect to the geometry of a molded part received in the mold cavity.

In further embodiments, the lower edge of the at least one chamber and the edge of the at least one mold cavity in the contact region can be designed to bond an introduced laminate to a corresponding edge region of a molded part. In the contact region, the laminate (film) and the edge region of the molded part are pressed against each other, for which purpose the corresponding tool components can have a pressing surface and/or other devices. This can include, for example, punching elements that cut an edge of the molded part together with the film.

In further embodiments, the lower edge of the at least one chamber can be heated in order to heat the laminate or the film and thus support the bond with the edge region of the molded part.

In further embodiments, a surface of the at least one mold cavity can be designed at least in portions to provide pressure equalization, so that the air between the laminate and a surface of the molded part can escape when the laminate is deformed, for example when it moves into an interior of the molded part. To provide pressure equalization, the surface can, for example, be open-pored or have openings at least in portions. In addition to the formation of the surface, the tool body can also be designed in the region of the at least one mold cavity to provide pressure equalization and can for example have channels for the escape of air. In further embodiments, the tool body can be designed to be porous, for example, at least in portions in the region of the at least one mold cavity. A porous structure and channels can, for example, be easily generated and produced using an additive manufacturing process, e.g., by means of 3D printing.

In further embodiments, the surface of the at least one mold cavity can have a plurality of openings, which in still further embodiments can be designed as suction openings, wherein air is additionally discharged from the space between the laminate and the molded part by providing a negative pressure.

In further embodiments, the region of the at least one chamber in which the at least one molding plunger can be displaced can be connected to a first device via which an overpressure can be generated in this region. For example, after the at least one molding plunger has reached a lower end position in the mold cavity, after the film or laminate has been moved almost completely against the surface of the molded part via the “air cushion” and the molding plunger and can be in contact with the surface of the molded part in some regions, a final pressure application can be exerted via the first device so that the film or laminate is pressed against the surface of the molded part and bonds with the surface of the molded part. For example, a molding pressure in the range of 2 to 12 bar, preferably in the range of 4 to 10 bar, preferably in the range of 6 to 8 bar can be generated in the region of the at least one chamber. For this purpose, the connection between the first device for generating overpressure and the at least one chamber can be closed as long as the molding tool is open and/or when the at least one molding plunger has not assumed its lower end position. Only after the lower end position has been reached a connection can be established and for example compressed air in the range of about 8 bar is introduced via the first device. The introduced compressed air then leads to a bonding of the laminate to the surface of the molded part. Since the laminate is already preformed via the air cushion and the molding plunger when pressure is applied, no defects (bubbles, overlaps, etc.) are formed. For this purpose, the at least one chamber and/or the at least one molding plunger can have a channel for introducing compressed air (molding air), which can be opened and closed for example via a valve or other means.

In further embodiments, the at least one molding plunger and/or the surface of the mold cavity can be heated. On the one hand, this allows the process temperature during lamination in the mold cavity to be kept at a required temperature level and cooling of the laminate can be prevented. On the other hand, the bond of the laminate to the fiber-containing material can be positively influenced if the temperature is kept at a definable temperature level and the molded part can be additionally dried.

In further embodiments, the at least one first seal and/or the at least one second seal can consist of or include an elastomer (e.g., silicone, TPE). In further embodiments, the at least one first seal and/or the at least one second seal can be designed as piston rings.

In further embodiments, the surface of the at least one mold cavity designed to provide pressure equalization can be connected to a second device for generating a negative pressure, via which a negative pressure can be created in the at least one mold cavity for suctioning the laminate or the films through the molded part. In still further embodiments, the distribution and formation of the openings and thus the suction effect can be different in regions of the surface of the at least one mold cavity in order to thus influence the distribution of the laminate. This may be necessary, for example, in order to take into account the distribution of the laminate in a specific geometry of the molded part.

The above-mentioned object is also achieved by a method for laminating three-dimensional molded parts made of a fiber-containing material, wherein at least one moldable laminate is applied to a surface of a molded part, using a molding tool according to one of the embodiments described above, at least including the following method steps:
inserting at least one molded part made of a fiber-containing material into at least one mold cavity of a tool body, wherein the molded part comes into contact with a surface/molding surface of the mold cavity,
inserting at least one laminate, wherein the laminate is applied to an edge region of the molded part and spans an interior space of the molded part,
closing the molding tool by relative displacement of the tool body with the at least one mold cavity and a tool component with at least one chamber in which a molding plunger that can be displaced relative to the chamber is received, wherein a lower edge of the at least one chamber presses the laminate in the edge region of the molded part against the molded part and against a corresponding edge of the at least one mold cavity, and
displacement of the at least one molding plunger in the at least one chamber, wherein a region of the at least one chamber in which the at least one molding plunger is displaceable is sealed from a remaining region of the at least one chamber via at least one first seal that is displaceable together with the at least one molding plunger in the chamber, so that the pressure on both sides of the laminate is kept substantially constant during the displacement of the at least one molding plunger and the laminate is pressed against the molded part synchronously with the movement of the at least one molding plunger.

The advantages for the molding tool described above also apply accordingly to a laminating method, wherein the material distribution of the laminate (e.g., a film) can be controlled.

In further embodiments, the laminate can be preheated before insertion and/or closing of the molding tool, wherein the preheating takes place up to a range in which the laminate is stretchable.

In further embodiments, an overpressure can be generated in the region of the at least one chamber in which the at least one molding plunger is displaced via at least one first device for applying pressure in this region (e.g., by applying pressure and introducing compressed air) when the at least one molding plunger has reached a lower end position. After premolding, the laminate can be pressed against the inner side of a molded part with high pressure (e.g., in the range of 6-9 bar).

Further features, embodiments and advantages result from the following illustration of exemplary embodiments with reference to the figures.

### BRIEF DESCRIPTION OF THE FIGURES

In the figures:

FIG. 1 depicts a schematic representation of a detail of a molding tool for the lamination of molded parts made of a fiber-containing material according to the prior art.

FIG. 2 depicts a schematic representation of a detail of a molding tool for the lamination of molded parts made of a fiber-containing material according to the prior art.

FIG. 3 depicts a schematic representation of a detail of a molding tool for laminating molded parts made of a fiber-containing material according to some embodiments.

FIG. 4 depicts a schematic representation of a detail of a molding tool for laminating molded parts made of a fiber-containing material according to some embodiments.

FIG. 5 depicts a schematic representation of a method for laminating three-dimensional molded parts made of a fiber-containing material, according to some embodiments.

### DETAILED DESCRIPTION

Various embodiments of the technical teaching described herein are shown below with reference to the figures. Identical reference signs are used in the figure description for identical components, parts and processes. Components, parts and processes that are not essential to the technical teachings disclosed herein or that are obvious to a person skilled in the art are not explicitly reproduced. Features specified in the singular also include the plural unless explicitly stated otherwise. This applies in particular to statements such as “a” or “one.”

### Prior Art

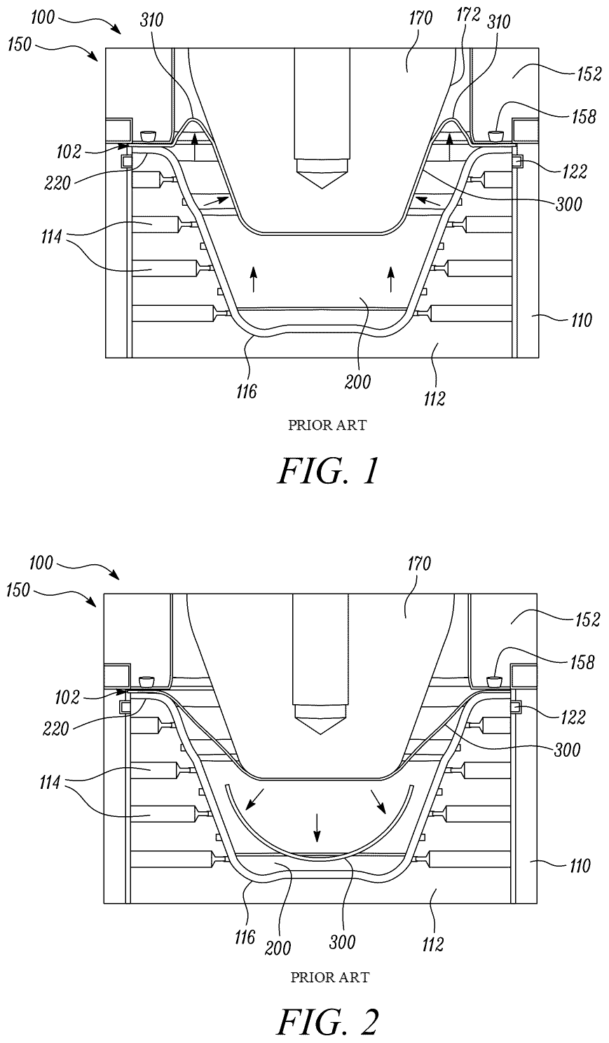

FIGS. 1 and 2 depict schematic representations of a detail of a molding tool 100 for laminating molded parts 200 made of a fiber-containing material according to the prior art.

A molding tool 100 can, for example, have a first tool body 110 that has at least one body 112 having a mold cavity 116, which in the embodiment shown is designed as a cavity. The molding surface of the mold cavity 116 has a plurality of openings on its surface that open into channels 114. The channels 114 open into a space 120, which is sealed at the top by a third seal 122. In the illustrated embodiment according to the prior art, the space 120 is connected to a second device for generating a negative pressure, so that suction can take place via the openings on the surface of the mold cavity 116.

The molding tool 100 can further include a tool component 150 having a chamber 154 in which a molding plunger 170 is received, which is relatively displaceable within the chamber 154 via a rod 174. A second seal 158 is arranged on the lower edge 159 of the tool component 150, which seals the chamber 154 and the mold cavity 116 from the outer environment of the molding tool 100 in the contact region 102 when the molding tool 100 is in the closed state, as shown in FIGS. 1 and 2.

In the mold cavity 116, a molded part 200 made of a fiber-containing material is received that was manufactured in a previous manufacturing step and inserted into the mold cavity 116. A laminating film 300 made of a plastics material (e.g., PP, PE with a thickness in the range of 0.1 mm to 1 mm, e.g., 0.3 mm) is placed on an edge region 220 of the molded part 200. The laminating film 300 extends over the entire interior 210 of the molded part 200. In the representations of FIGS. 1 and 2, the laminating film 300 has already been preformed via the molding plunger 170 and displaced into the interior space 210.

When laminating the molded part 200, according to the prior art embodiment a negative pressure is generated over the surface of the mold cavity 116, where the laminating film 300 is suctioned through the molded part 200 made of fiber-containing material after the molding tool 100 is closed and the tool component 150 rests on the first tool body 110 or the body 112.

Before the laminating film 300 is suctioned, an additional deflection or premolding of the laminating film 300 takes place by displacing the molding plunger 170 downwards in the direction of the molded part 200. Since there is a pressure difference between the region between the laminating film 300 and the molded part 200 and the region above the laminating film 300, the gas or gas mixture is displaced when the molding plunger 170 is moved, which can lead to a deformation of the laminating film 300 in the regions that do not hinder the expansion or deformation of the laminating film 300. Similar effects also occur if suction is started during the displacement of the molding plunger 170. In FIG. 1 it is shown that, for example, the laminating film 300 can be deformed upwards into the chamber 154 with the formation of bubbles 310.

Another disadvantage of the prior art embodiments (FIGS. 1 and 2) is that the laminating film 300 comes into direct contact with the surface 172 of the molding plunger 170, where the surface temperature of the molding plunger 170 is generally lower than the desired temperature of the laminating film 300, so that an unwanted cooling of the laminating film 300 occurs. This impairs the stretching properties of the laminating film 300, so that in the subsequent suction process, the laminating film 300 cannot be adequately bonded to the inner surface of the molded part 200.

As further shown schematically in FIG. 2, an uneven distribution of the laminating film 300 can also occur, where regions of the laminating film 300 first come into contact with the fiber-containing material of the molded part 200. In this case, the heated laminating film 300 is first bonded there, which leads to an additional stretching of the laminating film 300 in the adjacent regions. Additional stretching promotes the formation of weak points and can also lead to tearing of the laminating film 300.

### Embodiments According to the Present Disclosure

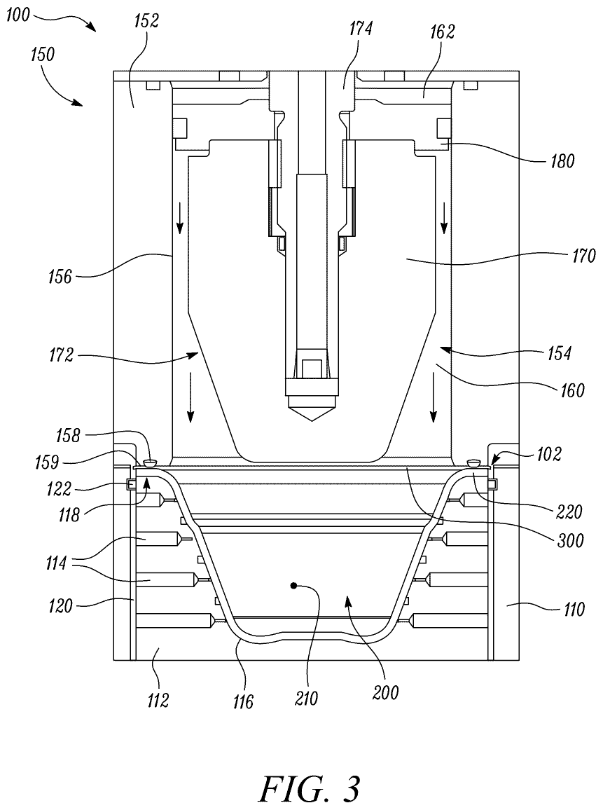

FIG. 3 depicts a schematic representation of a detail of a molding tool 100 for laminating molded parts 200 made of a fiber-containing material, according to some embodiments, where the disadvantages of the prior art are eliminated by the integration of a first seal 180. In FIG. 3, compared to the embodiments in FIGS. 1 and 2, substantially only those differences are discussed that provide the advantages over the prior art.

As shown in FIG. 3, a first seal 180 is arranged on a molding plunger 170, which seal divides the chamber 154 into two regions. A first region 160 is located between the first seal 180 and an inserted laminating film 300. A second region 162 is located above the first seal 180 and can, for example, be in contact with the environment.

In the embodiment shown, the first seal 180 is arranged directly above the molding plunger 170. In further embodiments, the first seal 180 can also be arranged directly on a molding plunger 170 or above a molding plunger 170. The embodiment of FIG. 3 depicts a first seal 180 with two outer sealing lips that rest against the side wall 156 of the chamber 154. To provide a seal during frequent movement on the side wall 156, this side wall can be coated with a suitable agent. Furthermore, a lubricant can be contained in the space between the two sealing lips, which supports a sealing effect of the first sealing lip 180. The first seal 180, like the at least one second seal 158 and the at least one third seal 122, can be made of a silicone material or TPE. In further embodiments, other flexible elements can also be used as sealing material for the various seals of the molding tool 100. The molding plunger 170 itself can include a metal or a metal alloy or a plastics material that has the required properties with respect to temperature resistance and adhesive properties. The rod 174 via which the molding plunger 170 is displaced in the tool component 150 can include a metal or a metal alloy, like a tool body 152 of the tool component 150 and the first tool body 110 and the at least one body 112.

The first seal 180 ensures that there is no pressure difference between the first region 160 above the laminating film 300 in the closed state of the molding tool 100 and the interior space 210 below the laminating film 300. The deformation of the laminating film 300 follows the displacement of the molding plunger 170 and its contour on the surface 172, where a type of “air cushion” can form on the surface 172 of the molding plunger 170 in the first region 160 of the chamber 154. Since the first region 160 is also defined by the position of the first seal 180, the first region 160 moves downwards as the molding plunger 170 moves. When the molding plunger 170 and the air cushion are displaced, a uniform distribution of the laminating film 300 results. This allows the laminating film 300 to be distributed over the entire inner surface of the molded part 200 without causing bubbles, wrinkles or holes in the laminating film 300. In particular, the laminating film 300 cannot deviate upwards when the molding plunger 170 is displaced because the pressure in the first region 160 of the chamber 154 counteracts deformation over the entire surface of the laminating film 300.

In further embodiments, a molding tool 100 can also have a plurality of bodies 112 with a mold cavity 116, which are received in corresponding receptacles of a first tool body 110. In such embodiments, a tool component 150 of the molding tool 100 (e.g., an upper tool) has a corresponding number of chambers 154 in which molding plungers 170 are received. This allows multiple molded parts 200 to be laminated simultaneously in one step. In further embodiments, the bodies 112 and molding plungers 170 can be exchanged to allow lamination of molded parts 200 with a different geometry in a molding tool 100. In further embodiments, instead of laminating an inner side as shown in FIG. 3, a laminating of an outer side of a molded part 200 can take place, where for this purpose a molding plunger can be designed, for example, in a shell-like manner (analogous to the design of the mold cavity 116 of FIG. 3), while the molded part rests on a plunger-like body.

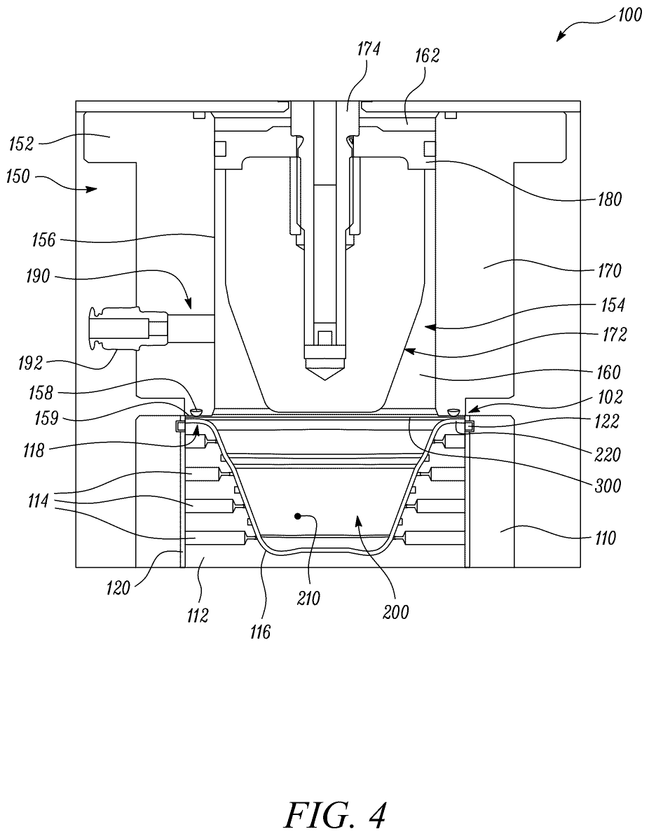

In the embodiment shown in FIG. 3, the air between the laminating film 300 and the molded part 200 escapes through the molded part 200 via the channels 114. Suction of the laminating film 300, as is absolutely necessary in the prior art, is not necessary in the embodiments shown (FIGS. 3 and 4). In the embodiment of FIG. 3, the displacement of the laminating film 300 and the bonding of the laminating film 300 to the inner side of the molded part 200 takes place only via the air cushion in the first region 160 and the molding plunger 170.

In further embodiments, the space 120 can be connected to a second device for generating a negative pressure, so that suction can take place via the openings on the surface of the mold cavity 116, for example to assist the escape of air between a laminating film 300 and a molded part 200 during lamination.

FIG. 4 depicts a schematic representation of a detail of a molding tool 100 for laminating molded parts 200 made of a fiber-containing material according to some embodiments.

In contrast to the representation of the embodiment of FIG. 3, the second tool body 152 has a channel 190 that projects into the first region 160 of the chamber 154. The channel 190 is bonded via a connector 192 to a first device for introducing compressed air, for example in the range of 6 to 9 bar. In the state of the molding tool 100 depicted in FIG. 4, the molding plunger 170 is in a starting position. The connection to the first device is interrupted via the first device itself, a valve or the like, so that there is no pressure equalization between the first region 160 and the environment. In other words, the first region 160 is sealed. The molding plunger 170 can then be moved downwards in the direction of the mold cavity 116, whereby the laminating film 300 is moved via the “air cushion” in the first region 160 and the molding plunger 170 downwards against the molded part 200. After the molding plunger 170 has reached its lower end position, compressed air, e.g., at 8 bar, is introduced into the first region 160 via the first device, and the laminating film 300 is in this way finally pressed against the inner surface of the molded part 200 and bonded to it. For this purpose, a valve or the like can be opened to allow the application of pressure.

In the lower end position, there is a small distance between the surface 172 of the molding plunger 170 and the inner surface of the molded part 200. Depending on the design and dimensions of the molding tool 100 and a molded part 200, there can be a distance between the surface 172 and the molded part 200 in the range of 2 to 20 mm in the lower end position, where the distance depends on the deep-drawing ratio of the product or molded part to be manufactured.

The channel 190 always projects into the first region 160 regardless of the position of the molding plunger 170 and must therefore be arranged accordingly. In still further embodiments (not shown), it is also possible for a channel for introducing compressed air for a final lamination step to run in the molding plunger 170 and project into the first region 160.

In still further embodiments, a plurality of openings can be provided that are connected to a first device via at least one channel 190 or a plurality of channels 190. The first device can, for example, include a compressor and/or a compressed air tank. In still further embodiments, the at least one channel 190, the first device, and/or the chamber 154 can include a valve or other apparatus that provides venting after the application of pressure in order to provide pressure equalization between the first region 160 and the environment of the molding tool 100.

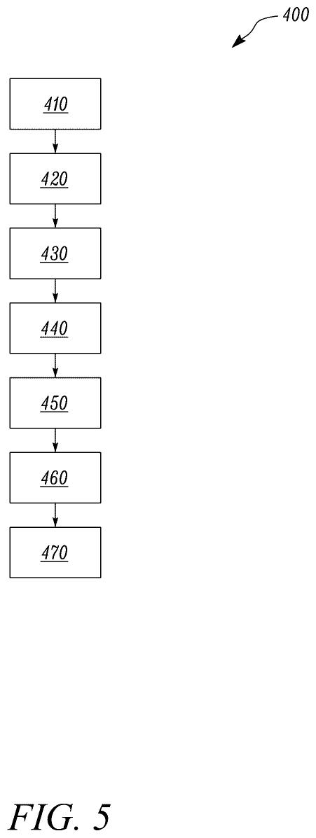

FIG. 5 depicts a schematic representation of a method 400 for laminating three-dimensional molded parts 200 made of a fiber-containing material according to some embodiments.

In a first optional step, the method 400 includes a manufacturing step 410. Molded parts 200 can be formed in a dry fiber molding process from an Airlaid or, for example, multiple paper layers arranged over one another. Alternatively, molded parts 200 can be pressed from a wet fiber pulp.

Subsequently, an insertion 420 of a previously manufactured molded part 200 into an opened molding tool 100 takes place, as depicted for example in FIG. 3 or 4, where the molded part 200 is inserted into a cavity that matches the outer (or inner) geometry of the molded part 200.

This is followed by the insertion 430 of a laminating film 300, which is preheated in a separate station in a previous step. Preheating is carried out to a temperature that allows deformation by the movement of a molding plunger 170.

During insertion, the laminating film 300 is aligned with the molded part 200 in such a way that an edge of the laminating film 300 comes to lie on an edge region 220 of the molded part 200. The introduction of the laminating film 300 can, for example, be carried out jointly for a plurality of mold cavities 116 of a molding tool 100, where the laminating films 300 are supplied individually. In further embodiments, a film web made of laminating film 300 can also be introduced between the tool body 110 and the tool component 150. When the molding tool 100 is closed by a relative displacement of the tool body 110 and the tool component 150, individual laminating films 300 can be separated from the film web by additional punching elements. For this purpose, punching blades can be provided, for example on an upper tool such as the tool component 150. In still further embodiments, regions can be pre-punched in a film web, in which case only the remaining holding bonds between the individual laminating films 300 and the film web are separated when the molding tool 100 is closed.

After the laminating film 300 has been placed on the edge region 220 of the molded part 200, the molding tool 100 is closed 440. The laminating film 300 is pressed against the edge region 220 of the molded part 200 in the contact region 102 between the lower edge 159 of the chamber 154 or the tool component 150 and an edge 118 of the mold cavity 116. The laminating film 300 is thus bonded to the edge region 220 when the molding tool 100 is closed. In the closed state of the molding tool 100, the remaining part of the laminating film 300 spans the interior 210 of the molded part 200.

After the molding tool 100 is closed, a displacement 450 of the molding plunger 170 begins. The molding plunger 170 is sealed from the environment and the remaining tool component 150 via a first seal 180 so that no gas exchange occurs. Furthermore, the first region 160 in the chamber 154 is closed at the bottom by the laminating film 300, which is sealed from the environment by the second seal 158.

By sealing the first region 160 of the chamber 154, the movement of the molding plunger 170 allows a substantially equal pressure to prevail on both sides of the laminating film 300, so that there are no bulges or other defects in the laminating film 300 and the laminating film 300 is evenly distributed over the inner surface of the molded part 200. Furthermore, a uniform downward pressure acts over the entire surface of the laminating film 300, so that no bulges (see FIG. 1) or the like can occur on the surface of the laminating film 300. The laminating film 300 is thus brought evenly downwards towards the inner side of the molded part 200. When the molding plunger 170 moves in the direction of a mold cavity 116, the laminating film 300 is deformed by the “air cushion” existing in the first region 160 and the molding plunger 170, where the contact between the surface 172 of the molding plunger 170 and the laminating film 300 is minimized.

In one embodiment, the laminating film 300 can be completely pressed against the surface of the molded part 200 by the “air cushion” and the molding plunger 170. In a further embodiment, as described above for the embodiment of FIG. 4, after reaching a lower end position of the molding plunger 170, pressure can be applied to the first region 160, where in this way the laminating film 300 is finally pressed against the surface of the molded part 200 and bonded to it. The air located between the laminating film 300 and the surface of the molded part 200 is pressed through the fiber-containing material of the molded part 200 and can escape via openings in the mold cavity 116. After the final lamination step, the first region 160 can be vented before the molding tool 100 is opened.

In further embodiments, suction can take place simultaneously with the displacement 450 of the molding plunger 170 or with a time offset via channels 114 and openings on the surface of the mold cavity 116 to generate a negative pressure, where the laminating film 300 is suctioned against the inner surface of the molded part 200 and/or the discharge of air between the laminating film 300 and the molded part 200 is supported. However, suction is not absolutely necessary for the lamination process itself, but merely supports the escape of the air.

After the laminating film 300 has completely come into contact with the inner surface of the molded part 200 and has bonded thereto, the molding plunger 170 moves back to its starting position and the molding tool 100 is opened 460. The laminated molded part 200 is then removed or ejected 470 from the molding tool 100 via ejectors or separate removal tools with grippers or suction cups. The laminated molded parts 200 can then be supplied for further processing or use.

Advantageously, the solution presented significantly improves the lamination of molded parts 200 made of a fiber-containing material because the bond between a laminating film 300 and the surface of a molded part 200 can be made over the entire surface without defects with consistent bonding properties and layer thickness.

### LIST OF REFERENCE SIONS

100 Molding tool
102 Contact region
110 Tool body
112 Body
114 Channel
116 Mold cavity
118 Edge
120 Space
122 Third seal
150 Tool component
152 Tool body
154 Chamber
156 Side wall
158 Second seal
159 Lower edge
160 First region
162 Second region
170 Molding plunger
172 Surface
174 Rod
180 First seal
190 Channel
192 Connector
200 Molded part
210 Interior space
220 Edge region
300 Laminating film
310 Bubble
400 Methods
410-470 Method steps

1. A molding tool for laminating three-dimensional molded parts made of a fiber-containing material, wherein at least one moldable laminate is applied to a surface of a molded part, the molding tool comprising a tool body with at least one mold cavity into which the molded part made of fiber-containing material is configured to be inserted, and a tool component with at least one molding plunger that is configured to be displaced relative to the at least one mold cavity and that is displaceably received in at least one chamber of the tool component, wherein the tool body and the tool component are configured to be brought into contact with one another such that a lower edge of the at least one chamber presses against an edge of the at least one mold cavity in a contact region, and wherein the at least one molding plunger in the at least one chamber is connected to at least one first seal that is configured to be displaced together with the at least one molding plunger in the at least one chamber and seals a region of the at least one chamber in which the at least one molding plunger is configured to be displaced from a remaining region of the at least one chamber.

2. The molding tool according to claim 1, further comprising at least one second seal arranged in the contact region between the edge of the at least one mold cavity and the at least one chamber.

3. The molding tool according to claim 2, wherein the at least one second seal is arranged on the lower edge of the at least one chamber.

4. The molding tool according to claim 1, wherein the at least one molding plunger and the at least one mold cavity have a substantially complementary geometry.

5. The molding tool according to claim 1, wherein the lower edge of the at least one chamber and the edge of the at least one mold cavity in the contact region are designed to bond an introduced laminate to a corresponding edge region of the molded part.

6. The molding tool according to claim 1, wherein the lower edge of the at least one chamber is heatable.

7. The molding tool according to claim 1, wherein a surface of the at least one mold cavity is designed at least in portions to provide pressure equalization.

8. The molding tool according to claim 7, wherein the surface of the at least one mold cavity has a plurality of openings.

9. The molding tool according to claim 7, wherein the surface of the at least one mold cavity designed to provide pressure equalization is connected to a second device for generating a negative pressure.

10. The molding tool according to claim 1, wherein the region of the at least one chamber in which the at least one molding plunger is displaceable is connected to a first device via which an overpressure is configured to be generated in this region.

11. The molding tool according to claim 1, wherein the at least one molding plunger and/or the surface of the at least one mold cavity are heatable.

12. The molding tool according to claim 1, wherein the at least one first seal includes an elastomer.

13. A method for laminating three-dimensional molded parts made of a fiber-containing material, wherein at least one moldable laminate is applied to a surface of a molded part, using a molding tool, at least comprising:
inserting at least one molded part made of a fiber-containing material into at least one mold cavity of a tool body, wherein the molded part comes into contact with a surface of the at least one mold cavity,
inserting at least one laminate, wherein the laminate is applied to an edge region of the molded part and spans an interior space of the molded part,
closing the molding tool by relative displacement of the tool body with the at least one mold cavity and a tool component with at least one chamber in which at least one molding plunger that is displaced relative to the at least one chamber is received, wherein a lower edge of the at least one chamber presses the laminate in the edge region of the molded part against the molded part and against a corresponding edge of the at least one mold cavity, and
displacement of the at least one molding plunger in the at least one chamber, wherein a region of the at least one chamber in which the at least one molding plunger is displaceable is sealed from a remaining region of the at least one chamber via at least one first seal that is displaceable together with the at least one molding plunger in the at least one chamber, such that a pressure on both sides of the laminate is kept substantially constant during the displacement of the at least one molding plunger and the laminate is pressed against the molded part synchronously with a movement of the at least one molding plunger.

14. The method according to claim 13, wherein an overpressure is generated via at least one first device for applying pressure in the region of the at least one chamber in which the at least one molding plunger is displaceable when the at least one molding plunger has reached a lower end position.
